(19) United States
(12) Patent Application Publication
(10) Pub. No.: US 2002/0158609 A1
(43) Pub. Date: Oct. 31, 2002

(54) Battery charger protection circuit

(76) Inventors: Robert H. Lavington, Emporia, KS (US); Jerry Wedel, Emporia, KS (US)

Correspondence Address: THOMAS B. LUEBBERING, HOVEY, WILLIAMS, TIMMONS & COLLINS, 2405 Grand, Suite 400, Kansas City, MO, 64108, US

(21) Appl. No.: 09/841,813

(22) Filed: Apr. 25, 2001

(51) Int. Cl. H02J 7/04; H02J 7/16

(52) U.S. Cl. 320/165

(57) ABSTRACT

A battery charger protection circuit (10) interposable between a charger system or charger battery (22) and a lead acid or gel cell charging battery (26) to allow 1-to-1 charging thereof while protecting against short circuit and reverse current conditions. The circuit (10) broadly comprises a printed circuit board (12); a self-resettable fuse (14); a Schottky barrier diode 16; and connection wires (18). The self-resettable fuse (14) includes a temperature-sensitive polymer fuse material operable at a predetermined maximum current, defined by the polymer fuse material's composition, to increase in electrical resistance and thereby reduce current flow.

### BACKGROUND OF THE INVENTION

1. Field of the Invention

The present invention is broadly concerned with short circuit and reverse current protection circuits for battery chargers. More particularly, the present invention relates to a battery charger protection circuit incorporating a temperature-sensitive self-resettable fuse providing short circuit protection, and a diode providing reverse current protection.

2. Description of the Prior Art

It is often desirable to charge an uncharged battery (hereafter charging battery) by, for example, electrically connecting the charging battery either directly to a charger system or indirectly thereto through a second battery (hereafter charger battery). Unfortunately, without protection, short circuit conditions could arise wherein the charging battery draws an unsafe amount of current from the charger system, or reverse current conditions could arise wherein the charging battery discharges back into the charger system or charger battery. In either case, damage can potentially result to one or both batteries, the charger system, and any other electrical load systems coupled therewith.

It is known to interpose fuses, resettable or otherwise, between the charging battery and the charger system or charger battery. Unfortunately, once tripped these fuses typically require manual resetting, which, in turn, requires that the fuse be accessibly located and housed. So locating the fuse can be undesirable from a design standpoint, particularly where such locations are limited and other systems are more preferably accessibly located. So housing the fuse typically requires either that the fuse be left undesirably exposed to ambient operating environments, including dust, residue, and debris, or that the fuse be protectively housed in a relatively complex and expensive enclosure having a sealed but moveable cover.

Due to the above-identified and other problems in the art, an improved battery charger protection circuit is needed.

### SUMMARY OF THE INVENTION

The present invention solves the above described and other problems in the art by providing a battery charger protection circuit interposable between a charger system or charger battery and a lead acid or gel cell charging battery to allow 1-to-1 charging thereof while protecting against short circuit and reverse current conditions. The preferred circuit broadly comprises a printed circuit board (PCB); a self-resettable fuse; a Schottky barrier diode; and connection wires. The PCB is conventional and operable to provide both a mounting surface and electrical traces for electrically connecting other components of the circuit. The self-resettable fuse is mounted to the PCB and comprises a temperature-sensitive polymer fuse material operable at a predetermined maximum current, defined by the polymer's composition, to increase in electrical resistance and thereby decrease current flow. The Schottky barrier diode is also mounted to the PCB and operable to prevent current flowing from the charging battery to the charger battery. The connection wires serve to facilitate electrical interposition of the circuit between the charger system or charger battery and the charging battery as well as any electrical loads also present.

Once assembled, the circuit can be completely encased, but for the connection wires, in a protective molded plastic housing. The housing preferably includes mounting tabs for accommodating screws or other fasteners which facilitates mounting the unit on a vehicular or other convenient surface.

These and other features of the battery charger circuit are described in more detail below in the section titled DETAILED DESCRIPTION OF A PREFERRED EMBODIMENT.

### BRIEF DESCRIPTION OF THE DRAWINGS

A preferred embodiment of the present invention is described in detail below with reference to the attached drawing figures, wherein:

FIG. 1 is a circuit schematic showing a preferred embodiment of the battery charger protection circuit of the present invention;

FIG. 2 is a top plan view of the battery charger protection circuit corresponding to the circuit schematic of FIG. 1;

FIG. 3 is a top plan view of the battery charger protection circuit of FIG. 2 encased within a protective housing; and

FIG. 4 is a block diagram showing the battery charger protection circuit incorporated into a preferred embodiment of a battery charger system.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF A PREFERRED EMBODIMENT

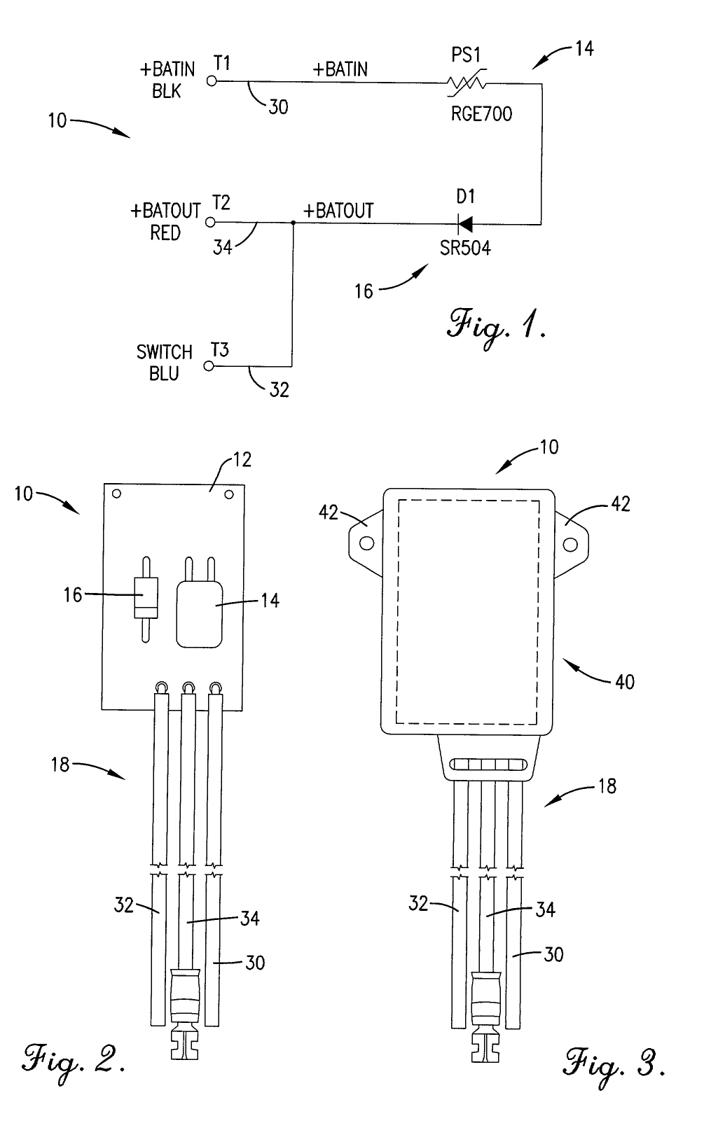

Referring to FIGS. 1 and 2, a battery charger protection circuit (hereafter the circuit) 10 is shown operable to allow charging of a lead acid or gel cell charging battery while protecting against short circuit and reverse current conditions. In a preferred embodiment, the circuit 10 broadly comprises a printed circuit board (PCB) 12; a self-resettable fuse 14; a Schottky barrier diode 16; and connection wires 18.

The PCB 12 is a conventional printed circuit board operable to provide a stable and secure surface for mounting and electrically interconnecting the other circuit components. As will be appreciated by those with skill in the electrical arts, leg or lead portions of the self-resettable fuse 14, Schottky barrier diode 16, and connection wires 18, are received within mounting holes provided in the PCB material, electrically conductive traces extend between and surround these mounting holes, and the leg or lead portions are soldered or otherwise electrically connected to these traces. Though final dimensions will vary with design considerations, in a preferred embodiment the PCB 12 measures 2.000 +/−0.015 inch long and 1.280 +/−0.015 inch wide.

The self-resettable fuse 14 preferably includes a heat-activated polymerfuse material whose heat tolerance characteristics, as determined by the polymer's composition, determine the amount of current the fuse will carry before rapidly increasing in electrical resistance. Thus, the self-resettable fuse 14 is preferably a so-called polymeric positive temperature coefficient (PPTC) self-resettable fuse that functions as a temperature-variable resistance element. Under normal operating conditions, the self-resettable fuse 14 presents only very low resistance and associated current losses. However, when a short circuit or overcurrent condition arises, thereby increasing the polymer's temperature, the polymer's electrical resistance rapidly increases to reduce current flow. As the fuse 14 cools, resistance decreases such that the fuse 14 effectively self-resets. The self-resettable fuse 14 also protects against excessive temperatures potentially caused by faulty or incompatible charger systems or charger batteries.

In a preferred embodiment, the self-resettable fuse 14 is operable to carry up to 7A before rapidly increasing in resistance such that current flow is substantially decreased. Such self-resettable fuses are available, for example, from Raychem Corporation and Bourns Incorporated.

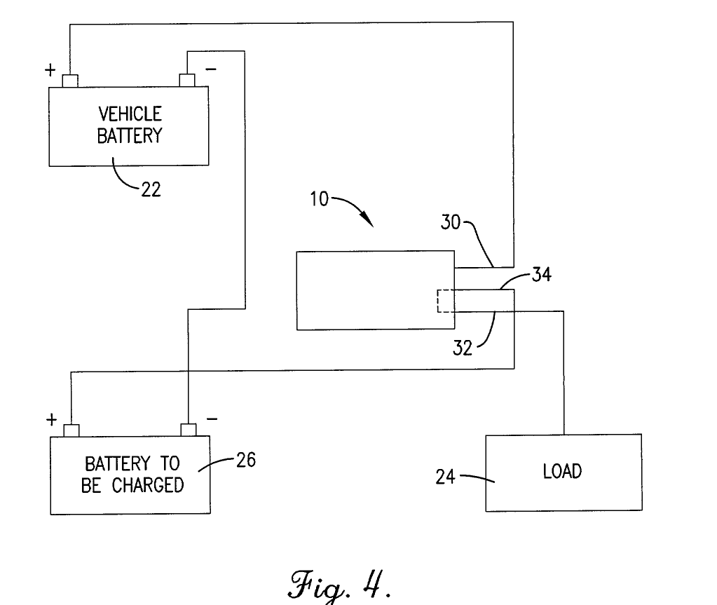

The Schottky barrier diode 16 is conventional and included to prevent inadvertent discharging of the charging battery 26 into the charger system or charger battery 24 (see FIG. 4). Thus, the Schottky barrier diode 16 is preferably operable to allow only forward current flow (to the charging battery 26), and to not allow reverse current flow (from the charging battery 26).

The connection wires 18 are conventional electrical wiring operable to connect the charger system or charger battery 22 via the battery charger protection circuit 10 to both an electrical load 24, if present, and the charging battery 26. The connection wires 18 preferably comprise a black power wire 30; a blue load wire 32; and a red charging wire 34. The black power wire 30 is preferably 16AWG, connected at a first end to an electrically conductive trace of the PCB 12, and at a second end to a positive terminal of the charger battery 22. The blue load wire 32 is preferably 14 AWG, connected at a first end to an electrically conductive trace of the PCB 12, and at a second end to the electrical load 24. In other, equally preferred embodiments, the blue load wire 32 may be eliminated. The red charging wire 34 is preferably 14 AWG, connected at a first end to an electrically conductive trace of the PCB 12, and at a second end to a positive terminal of the charging battery 26. The second end of the red charging wire 34 may be equipped with a conventional female electrical terminal 38 to facilitate convenient connection and disconnection.

Referring to FIG. 3, once assembled, the circuit 10 may be completely encased, but for the second ends of the connection wires 18, in a molded plastic housing 40 to both protect the circuit 10 and facilitate mounting thereof upon a vehicular or other surface. The molded plastic housing 40 preferably presents mounting tabs 42 operable to receive screws or other fasteners for securing the housing 40 to a surface. The encasing molded plastic housing 40 provides an additional benefit by securely gripping the first ends of the connection wires 18, thereby helping to prevent them from being disconnected from the PCB 12 due to rough handling.

In operation, an application-appropriate circuit 10 is chosen based upon its performance characteristics, particularly temperature-sensitivity, as determined primarily by the polymer fuse material's composition. Next, screws or other fasteners are used in conjunction with the mounting tabs 42 to secure the encased circuit 10 to a surface. Because the circuit 10 is self-resettable, the surface need not be conveniently accessible to a user.

Referring to FIG. 4, the second end of the black power wire 30 is connected to the positive terminal of the charger battery 22. The second end of the blue load wire 32 is connected to any other electrical load 24 present. The second end of the red charging wire 34 is connected to the positive terminal of the charging battery 26. Additionally, respective negative terminals of the charger and charging batteries 22,26 are connected together or otherwise connected so as to establish a common electrical ground.

Protected charging of the charging battery 26 then occurs. As noted above, the present invention provides both short circuit protection and reverse current protection. The self-resettable fuse 14 protects the charger system, charger battery 26, and charging battery 26 from current exceeding the predetermined maximum allowable by the temperature-sensitive polymer fuse material. The Schottky barrier diode 16 protects the charger system and charger battery 22 from inadvertent and undesirable discharge of the charging battery 26 resulting in a reverse current condition wherein current flows from rather than to the charging battery 26.

The circuit 10 is designed to charge lead acid or gel cell batteries only, not NiCads. The circuit 10 provides a 1-to-1 charging ratio, meaning the charger battery 22 and charging battery 26 should have the same voltage capacity (e.g., 12V-to-12V, 24V-to-24V).

Charging rates will vary depending upon the condition of the charging battery 26. For example, charging current will decrease as the charge level of the charging battery 26 increases. For reference, a completely discharged 12 VDC 5 APH battery will take approximately 30 minutes using a 13.5 VDC charging rate to achieve a 13.2 VDC charge.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A battery charger protection circuit operable to provide short-circuit and reverse current protection during charging of a charging battery by a charger system, the battery charger protection circuit comprising:
a self-resettable fuse electrically interposed between the charging battery and the charger system and incorporating a temperature-sensitive polymer fuse material operable at a predetermined maximum current to increase in electrical resistance; and
a diode interposed between the charging battery and charger system and operable to restrict current flow from the charging battery to the charger system.

2. The battery charger protection circuit as set forth in claim 1, wherein the predetermined maximum current is 7A.

3. The battery charger protection circuit as set forth in claim 1, wherein the predetermined maximum current is determined by a composition of the temperature-sensitive polymer fuse material.

4. The battery charger protection circuit as set forth in claim 1, wherein the diode is a Schottky barrier diode.

5. The battery charger protection circuit as set forth in claim 1, further including a printed circuit board whereupon the self-resettable fuse and diode are operatively mounted.

6. The battery charger protection circuit as set forth in claim 1, further including a molded plastic housing operable to completely encase the self-resettable fuse and diode but for an external electrical connection.

7. A battery charger protection circuit operable to provide short-circuit and reverse current protection during charging of a charging battery by a charger system, the battery charger protection circuit comprising:
a self-resettable fuse electrically interposed between the charging battery and the charger system and incorporating a temperature-sensitive polymer fuse material operable at a predetermined maximum current to increase in electrical resistance;
a diode interposed between the charging battery and charger system and operable to restrict current flow from the charging battery to the charger system;
a printed circuit board whereupon the self-resettable fuse and diode are operatively mounted; and
a molded plastic housing operable to completely encase the self-resettable fuse and diode but for an external electrical connection.

8. The battery charger protection circuit as set forth in claim 7, wherein the predetermined maximum current is 7A.

9. The battery charger protection circuit as set forth in claim 7, wherein the predetermined maximum current is determined by a composition of the temperature-sensitive polymer fuse material.

10. The battery charger protection circuit as set forth in claim 7, wherein the diode is a Schottky barrier diode.

11. A battery charger system comprising:
a charging battery having a first positive terminal;
a charger battery having a second positive terminal, wherein the first and second positive terminals are electrically coupled;
a self-resettable fuse interposed between the first and second positive terminals and incorporating a temperature-sensitive polymer fuse material operable at a predetermined maximum current to increase in electrical resistance;
a diode interposed between the first and second positive terminals and operable to restrict current flow from the charging battery to the charger battery;
a printed circuit board whereupon the self-resettable fuse and diode are operatively mounted; and
a molded plastic housing operable to completely encase the self-resettable fuse and diode but for any external electrical connections.

12. The battery charger system as set forth in claim 11, wherein the predetermined maximum current is 7A.

13. The battery charger system as set forth in claim 11, wherein the predetermined maximum current is determined by a composition of the temperature-sensitive polymer fuse material.

14. The battery charger system as set forth in claim 11, wherein the diode is a Schottky barrier diode.
